(19) United States
(12) Patent Application Publication
(10) Pub. No.: US 2024/0032507 A1
(43) Pub. Date: Feb. 1, 2024

(54) Small Animal Washing Device

(71) Applicant: Christopher Williams, Colorado Springs, CO (US)

(72) Inventor: Christopher Williams, Colorado Springs, CO (US)

(21) Appl. No.: 18/339,333

(22) Filed: Jun. 22, 2023

Related U.S. Application Data
(60) Provisional application No. 63/392,894, filed on Jul. 28, 2022.

(51) Int. Cl. A01K 13/00

(52) U.S. Cl. CPC A01K 13/001

(57) ABSTRACT

The present invention relates to a novel small animal washing device. The device is designed to be an enclosed bathtub for pets and other small animals. The device comprises a housing with an inlet for a hose, as well as a tray component having a drain opening with an attached cap to drain the water from the housing after use. The housing includes two hand openings with sliding closures to wash the animal as he/she sits or stands within the tray component. The device keeps all water contained within while the pet remains calm and comfortable when being bathed.

### CROSS-REFERENCE TO RELATED APPLICATION

The present application claims priority to, and the benefit of, U.S. Provisional Application No. 63/392,894, which was filed on Jul. 28, 2022, and is incorporated herein by reference in its entirety.

### FIELD OF THE INVENTION

The present invention relates generally to the field of small animal washing devices. More specifically, the present invention relates to an improved small animal washing device that provides users with an enclosed bathing system for small pets/animals. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in small animal washing devices. Bathing and drying a pet or small animal can be difficult and time consuming. A pet or small animal may try to run away during a bath and shake their wet fur all over a bathroom or other part of a user's house. Furthermore, keeping hold of the small pet while trying to bathe them may also be nearly impossible.

Specifically, domesticated animal pets are a popular member of many households. Such animals are reliant upon their human caretakers for their basic needs. Among these needs are hygienic needs such as frequent bathing. The process of bathing common pets such as cats, dogs, and the like, provides health benefits, prevents unwanted odors, and contributes to the overall appearance of the animal.

Many conventional methods of bathing animals are inconvenient, as washing pets in common bathtubs can lead to smelly or dirty tubs, difficult reaching for the caretaker, and uncomfortable brushing for the animal. Attempting to wash a pet outdoors is difficult and unpredictable as well and leaves the animals prone to further dirtying. Additionally, utilizing other indoor water sources such as sinks can lead to clogged drains and the like. Further, taking the pet to a salon or otherwise hiring another individual to maintain the pet's appearance can result in very significant costs over the lifetime of the pet.

Therefore, there exists a long-felt need in the art for a small animal washing device that provides users with an enclosed bathing system for small pets. There is also a long-felt need in the art for a small animal washing device that features a small tray to accommodate a pet inside the system. Further, there is a long-felt need in the art for a small animal washing device that also includes a handle and release valve to drain extra water. Moreover, there is a long-felt need in the art for a device that includes a plug to power the water hose adapter to dispense warm water onto the pet. Further, there is a long-felt need in the art for a small animal washing device that enables pet owners to place their hands through the front openings to lather and bathe their pet. Finally, there is a long-felt need in the art for a small animal washing device that offers a way to keep small animals calm while bathing them.

The subject matter disclosed and claimed herein, in one embodiment thereof, comprises a small animal washing device. The device is designed to be an enclosed bathtub for pets and other small animals. The device comprises a housing with an inlet for a hose, as well as a tray component having a drain opening with an attached cap to drain the water from the housing after use. The housing includes two hand openings with sliding closures to wash the animal as he/she sits or stands within the tray component. The device keeps all water contained within, while the pet remains calm and comfortable when being bathed.

In this manner, the small animal washing device of the present invention accomplishes all of the foregoing objectives and provides users with a device that allows small animals to fit comfortably inside while bathing. The device provides users with a way to make baths quick and easy for small pets. Further, the device comprises a hinged lid for easy open and close.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a small animal washing device. The device is designed to be an enclosed bathtub for pets and other small animals. The device comprises a housing which includes two hand openings to wash the animal as they sit or stand within the housing. The device keeps all water contained within while the pet remains calm and comfortable when being bathed.

The present invention describes a small pet washing device, which provides a means for restraining and bathing a small domestic pet such as a small dog, a cat, or a similarly shaped pet. The device is portable and rests upon a counter near a conventional sink or similar vessel comprising a water faucet and a drain means. The device comprises a housing shaped as a rectangular box structure, or any other suitable shape as is known in the art. In one embodiment, the housing comprises a hinged lid which opens and closes to allow a small pet to be placed inside the housing. The housing forms a rectangular inner space with surrounding wall structures.

In one embodiment, the housing generally comprises a bottom wall, a top wall, a first lateral wall, a second lateral wall, a back wall, and a front wall.

In one embodiment, the hinged lid is secured to the back wall via hinges. The hinges are affixed to the housing in a conventional manner using fasteners. However, it is understood that the hinges may also be integrally molded therein and as such, should not be interpreted as a limiting factor of the device. The hinged lid may be pivoted downward and secured in a relatively horizontal orientation when the device is in use, via three (3) locking clasps along adjacent edges of the lid.

The device is made of a lightweight, durable material such as plastic, fiberglass, or the like and manufactured through common extruding and molding processes. The device can be molded in various colors and patterns to match existing decor or may be molded in transparent or translucent plastic as well, such that a user can view the interior of the housing, based upon a user's preference. The device is to be suitably sized so as to be portable and capable of temporarily housing a small house pet during washing. The device is approximately eight (8) inches in depth, ten (10) inches in height, and thirteen (13) inches in length; however, the device may be introduced in various sizes such as “small”, “medium”, and “large” so as to accommodate various size pets, and as such should not be interpreted as a limiting factor of the device.

In one embodiment, the front wall comprises a set of openings or apertures for a user to place their hands to wash the animal within the housing. Any number of opening can be utilized as is known in the art, depending on the needs and/or wants of a user. However, typically the housing comprises two openings. Further, the openings can be any suitable shape as is known in the art, depending on the needs and/or wants of a user. However, typically the openings are circular, but do not have to be.

In one embodiment, the openings comprise doors or other closure means which seal the openings when not in use. The doors can be sliding doors, hinged doors, or merely flap doors, etc., or any other suitable closure means as is known in the art. In one embodiment, the doors are sliding coverings or doors. Each of the coverings is positioned over one of the openings in a closed position or in an open position positioned away from the openings. The coverings may be slid on guides attached to the front wall.

In one embodiment, the housing comprises a tray component that is positioned on the bottom wall of the housing. The tray component can be any suitable size and shape as is known in the art, as long as the tray component fits within the housing. The tray component comprises a solid bottom member and a raised perimeter comprising a set of opposing front and back walls and a second set of opposing lateral walls. The small pet sits or stands within the tray component during bathing. In another embodiment, the tray component is raised on one end or slanted/angled, such that water runs down the tray component. Further, in another embodiment, the tray component can just be manually raised on one side to drain water to the other end. In yet another embodiment, the tray component comprises a plurality of molded-in perforations which provide a fluid straining means for the wastewater, thereby removing pet hair and other contaminants while providing sufficient drainage therethrough, during the washing process. Said perforations may comprise various geometric shapes such as rectangles, circles, or the like, and extend through the tray component.

In one embodiment, the device provides a means to drain wastewater produced by the pet washing process from the housing and/or tray component via a drain conduit which protrudes downwardly from the drain located at a bottom surface of the housing. Further, the device can be positioned such that it rests upon a sink or near a sink, thereby directing said wastewater exiting said drain conduits, into the existing sink drain, and thereby utilizing an existing drainage system within a residence.

Specifically, the tray component comprises a water release valve or drain opening with attached cap to drain the water from the tray component into the housing. In another embodiment, the housing also comprises a water release valve or drain opening with attached cap to drain water from the tray component and housing out of the device. In another embodiment, the water release valve or drain opening is fluidly coupled to both the tray component and the housing. The tray component is then angled toward the drain opening.

In one embodiment, the housing comprises an inlet for a hose and a corresponding water inlet tube. An actuator valve for selectively opening or closing the water inlet tube is fluidly coupled to the water inlet tube. The valve is positioned outside of the housing for use by a user.

In another embodiment, the housing further provides a plumbing means to receive a flow of pressurized supply water. Said supply water is subsequently discharged onto the pet via a plurality of water delivery apertures positioned within the housing. After use, a water release valve located along a bottom surface of the housing allows complete drainage of residual supply water from the housing and tray component.

In one embodiment, the plurality of water delivery apertures are a plurality of nozzles positioned within the housing and fluidly coupled to the water inlet tube. The plurality of nozzles are mounted with the housing near the top of the back wall. The nozzles are each generally directed toward a central area of the interior of the housing. Each of the nozzles is elongated and generally extends out from the back wall. Any suitable number of nozzles can be utilized as is known in the art and the nozzles can be positioned at different areas of the back wall.

In one embodiment, the housing also provides a means to optionally mix a liquid supplement such as shampoo, flea medication, etc., into the supply water via a liquid venturi unit or other suitable mixing means. Generally, the venturi unit is permanently affixed to a side surface of the housing. A length of supply water tubing provides a plumbing connection between the venturi unit and a source of supply water, such as an existing sink faucet.

In yet another embodiment, the small animal washing device comprises a plurality of indicia.

In use, a dog or other small animal is positioned within the housing, such that it stands or sits on the tray component. A conventional water supply coupled to the water inlet and a conventional drain hose is coupled to the drain opening. The actuator valve is opened, and water sprays the dog from above. The coverings for the openings may be removed by sliding the coverings to the right or left, allowing a user to place their hands within the openings to wash the dog. Specifically, a user can reach inside the housing to apply shampoo or other solutions to the coat of the dog. The drain allows the water to run off so that the interior of the housing and tray component does not fill with water.

In yet another embodiment, a method of bathing a small animal while keeping the animal calm and comfortable is described. The method includes the steps of providing a small animal washing device comprising a housing with a hose inlet and a tray component with a drain opening, and two hand openings for washing the animal. The method also comprises positioning the animal within the housing, such that the animal sits or stands on the tray component. Further, the method comprises shutting the lid of the device to retain the animal within the housing during use. The method also comprises, placing a user's hands through the hand openings to be able to wash the animal within the housing. Further, the method comprises, washing the animal within the device and draining the water once done. Finally, opening the lid and removing the animal once the bath is complete.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the small animal washing device of the present invention in accordance with the disclosed architecture;

FIG. 2 illustrates a perspective view of one embodiment of the small animal washing device of the present invention wherein there is a hinged lid in accordance with the disclosed architecture;

FIG. 3 illustrates a perspective view of one embodiment of the small animal washing device of the present invention in use in accordance with the disclosed architecture; and

FIG. 4 illustrates a flowchart showing the method of bathing a small animal while keeping the animal calm and comfortable in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a small animal washing device that provides users with an enclosed bathing system for small pets. There is also a long-felt need in the art for a small animal washing device that features a small tray to accommodate a pet inside the system. Further, there is a long-felt need in the art for a small animal washing device that also includes a handle and release valve to drain extra water. Moreover, there is a long-felt need in the art for a device that includes a plug to power the water hose adapter to dispense warm water onto the pet. Further, there is a long-felt need in the art for a small animal washing device that enables pet owners to place their hands through the front openings to lather and bathe their pet. Finally, there is a long-felt need in the art for a small animal washing device that offers a way to keep small animals calm while bathing them.

The present invention, in one exemplary embodiment, is a novel small animal washing device. The device is designed to be an enclosed bathtub for pets and other small animals. The device comprises a housing with an inlet for a hose, as well as a tray component having a drain opening with an attached cap to drain the water from the housing after use. The housing includes two hand openings with sliding closures to wash the animal as he/she sits or stands within the tray component. The device keeps all water contained within while the pet remains calm and comfortable when being bathed. The present invention also includes a novel method of bathing a small animal while keeping the animal calm and comfortable. The method includes the steps of providing a small animal washing device comprising a housing with a hose inlet and a tray component with a drain opening, and two hand openings for washing the animal. The method also comprises positioning the animal within the housing, such that the animal sits or stands on the tray component. Further, the method comprises shutting the lid of the device to retain the animal within the housing during use. The method also comprises, placing a user's hands through the hand openings to be able to wash the animal within the housing. Further, the method comprises, washing the animal within the device and draining the water once done. Finally, opening the lid and removing the animal once the bath is complete.

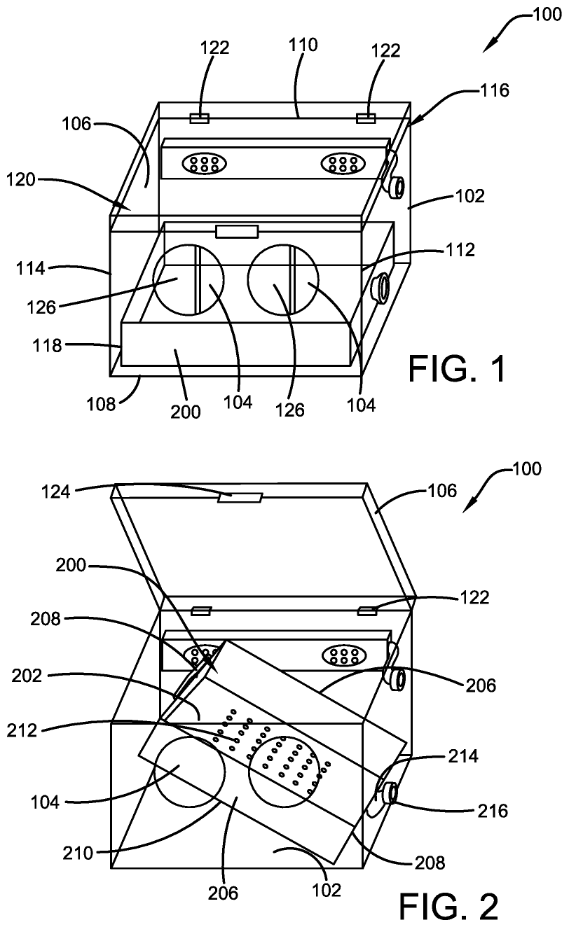

Referring initially to the drawings, FIG. 1 illustrates a perspective view of one embodiment of the small animal washing device 100 of the present invention. In the present embodiment, the small animal washing device 100 is an improved small animal washing device that is an enclosed bathtub for cats, dogs, and other small animals 300. The small animal washing device 100 further comprises a housing 102 which includes two hand openings 104 to wash the animal 300 as they sit or stand within the housing 102. The device 100 keeps all water contained within while the pet 300 remains calm and comfortable when being bathed.

The small pet washing device 100 provides a means for restraining and bathing a small domestic pet 300 such as a small dog, a cat, or a similarly shaped pet. The device 100 is portable and rests upon a counter near a conventional sink or similar vessel comprising a water faucet and a drain means (not shown). The device 100 comprises a housing 102 shaped as a rectangular box structure, or any other suitable shape as is known in the art, depending on the needs and/or wants of a user. In one embodiment, the housing 102 comprises a hinged lid 106 which opens and closes to allow a small pet 300 to be placed inside the housing 102. The housing 102 forms a rectangular inner space 120 with surrounding wall structures. Generally, the housing 102 comprises a bottom wall 108, a top wall 110, a first lateral wall 112, a second lateral wall 114, a back wall 116, and a front wall 118.

Further, the hinged lid 106 is secured to the back wall 116 via hinges 122. The hinges 122 are affixed to the housing 102 in a conventional manner using fasteners. However, it is understood that the hinges 122 may also be integrally molded therein and as such, should not be interpreted as a limiting factor of the device 100. The hinged lid 106 may be pivoted downward and secured in a relatively horizontal orientation when the device 100 is in use, via three (3) locking clasps 124 along adjacent edges of the lid 106.

Additionally, the device 100 is made of a lightweight, durable material such as plastic, fiberglass, or the like, and manufactured through common extruding and molding processes. Specifically, the device 100 can be manufactured from heat-sealable plastic or polymers, such as polypropylene or acrylonitrile-butadiene-styrene (ABS), or any other suitable material as is known in the art, such as, but not limited to, acrylic, polycarbonate, polyethylene, polyethylene terephthalate, polyvinyl chloride, polystyrene, etc. Generally, the small animal washing device 100 is also manufactured from a material that is water resistant or waterproof, or the housing 102 comprises a coating that is water resistant or waterproof. Furthermore, the device 100 can be molded in various colors and patterns to match existing decor or may be molded in transparent or translucent plastic as well, such that a user can view the interior of the housing 102, based upon a user's preference.

Generally, the device 100 is to be suitably sized so as to be portable and capable of temporarily housing a small house pet 300 during washing. Specifically, the device 100 is approximately eight (8) inches in depth, ten (10) inches in height, and thirteen (13) inches in length; however, the device 100 may be introduced in various sizes such as “small”, “medium”, and “large” so as to accommodate various size pets 300, and as such, should not be interpreted as a limiting factor of the device 100.

In one embodiment, the front wall 118 comprises a set of openings or apertures 104 for a user to place their hands to wash the animal 300 within the housing 102. Any number of openings 104 can be utilized as is known in the art, depending on the needs and/or wants of a user. However, typically the housing 102 comprises two openings 104. Further, the openings 104 can be any suitable shape as is known in the art, depending on the needs and/or wants of a user. However, typically the openings 104 are circular, but do not have to be.

Additionally, the openings 104 comprise doors 126 or other closing means which seal the openings 104 when not in use. The doors 126 can be sliding doors, hinged doors, or merely flap doors, etc., or any other suitable closure means as is known in the art, depending on the needs and/or wants of a user. In one embodiment, the doors 126 are sliding coverings or doors. Each of the coverings 126 is positioned over one of the openings 104 in a closed position or in an open position positioned away from the openings 104. The coverings 126 may be slid on guides (not shown) attached to the front wall 118 or secured to any suitable fastener which allows the coverings 126 to slide over the openings 104 and back.

As shown in FIG. 2, the housing 102 comprises a tray component 200 that is positioned on the bottom wall 108 of the housing 102. The tray component 200 can be any suitable size and shape as is known in the art, as long as the tray component 200 fits within the housing 102. The tray component 200 comprises a solid bottom member 202 and a raised perimeter 204 comprising a set of opposing front and back walls 206 and a second set of opposing lateral walls 208. The small pet 300 sits or stands within the tray component 200 during bathing. In another embodiment, the tray component 200 is raised on one end or slanted/angled 210, such that water runs down the tray component 200. Further, in another embodiment, the tray component 200 can be manually raised on one side to drain water to the other end. In yet another embodiment, the tray component 200 comprises a plurality of molded-in perforations 212 which provide a fluid straining means for the wastewater, thereby removing pet hair and other contaminants while providing sufficient drainage therethrough, during the washing process. Said perforations 212 may comprise various geometric shapes such as rectangles, circles, squares, etc., or any other suitable shape as is known in the art and extend through the tray component 200.

Furthermore, the device 100 provides a means to drain wastewater produced by the pet washing process from the housing 102 and/or tray component 200 via a drain conduit 214 which protrudes downwardly from the drain 216 located at a bottom surface of the housing 102. Further, the device 100 can be positioned such that it rests upon a sink or near a sink, thereby directing said wastewater exiting said drain conduit 214 into the existing sink drain, and thereby utilizing an existing drainage system within a residence.

Specifically, the tray component 200 comprises a water release valve or drain opening with attached cap 216 to drain the water from the tray component 200 into the housing 102. In another embodiment, the housing 102 also comprises a water release valve or drain opening with attached cap 216 to drain water from the tray component 200 and housing 102 out of the device 100. In another embodiment, the water release valve or drain opening 216 is fluidly coupled to both the tray component 200 and the housing 102. The tray component 200 is then angled toward the drain opening 216 to drain water.

Additionally, the housing 102 comprises an inlet 218 for a hose and a corresponding water inlet tube 220. An actuator valve 222 for selectively opening or closing the water inlet tube 220 is fluidly coupled to the water inlet tube 220. The valve 222 is positioned outside of the housing 102 for use by a user. The actuator valve 222 allows a user to control the flow of water within the housing 102.

Further, the housing 102 provides a plumbing means to receive a flow of pressurized supply water. Said supply water is subsequently discharged onto the pet via a plurality of water delivery apertures 224 positioned within the housing 102. After use, a water release valve 216 located along a bottom surface of the housing 102 allows complete drainage of residual supply water from the housing 102 and tray component 200.

In one embodiment, the plurality of water delivery apertures 224 are a plurality of nozzles 226 positioned within the housing 102 and fluidly coupled to the water inlet tube 220. The plurality of nozzles 226 are mounted with the housing 102 near the top of the back wall 116. The nozzles 226 are each generally directed toward a central area of the interior of the housing 102. Each of the nozzles 226 is elongated and generally extends out from the back wall 116. Any suitable number of nozzles 226 can be utilized as is known in the art and the nozzles 226 can be positioned at different areas of the back wall 116.

In another embodiment, the housing 102 also provides a means to optionally mix a liquid supplement 232 such as shampoo, flea medication, etc., into the supply water via a liquid venturi unit 228 or other suitable mixing means. Generally, the venturi unit 228 is permanently affixed to a side surface of the housing 102. A length of supply water tubing 230 provides a plumbing connection between the venturi unit 228 and a source of supply water, such as an existing sink faucet, or other suitable water supply as is known in the art.

In yet another embodiment, the small animal washing device 100 comprises a plurality of indicia 234. The housing 102 of the device 100 may include advertising, a trademark, or other letters, designs, or characters, printed, painted, stamped, or integrated into the housing 102, or any other indicia 234 as is known in the art. Specifically, any suitable indicia 234 as is known in the art can be included, such as, but not limited to, patterns, logos, emblems, images, symbols, designs, letters, words, characters, animals, advertisements, brands, etc., that may or may not be pet or grooming/brand related.

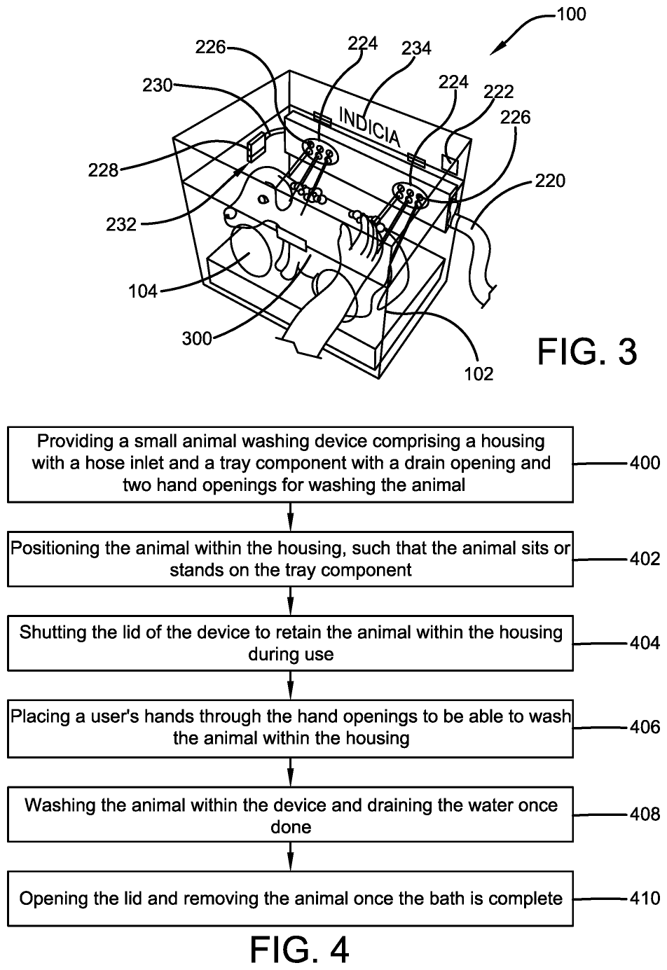

As shown in FIG. 3, in use the small animal washing device 100 allows a dog or other small animal 300 to be positioned within the housing 102, such that it stands or sits on the tray component 200. A conventional water supply is coupled to the water inlet 218 and a conventional drain hose/conduit 214 is coupled to the drain opening 216. The actuator valve 222 is opened and water sprays the dog 300 from above. The coverings 126 for the openings 104 may be removed by sliding the coverings 126 to the right or left, allowing a user to place their hands within the openings 104 to wash the dog 300. Specifically, a user can reach inside the housing 102 to apply shampoo or other solutions 232 to the coat of the dog 300. The drain 216 allows the water to run off so that the interior of the housing 102 and tray component 200 does not fill with water.

FIG. 4 illustrates a flowchart of the method of bathing a small animal while keeping the animal calm and comfortable. The method includes the steps of at 400, providing a small animal washing device comprising a housing with a hose inlet and a tray component with a drain opening, and two hand openings for washing the animal. The method also comprises at 402, positioning the animal within the housing, such that the animal sits or stands on the tray component. Further, the method comprises at 404, shutting the lid of the device to retain the animal within the housing during use. The method also comprises at 406, placing a user's hands through the hand openings to be able to wash the animal within the housing. Further, the method comprises at 408, washing the animal within the device and draining the water once done. Finally, at 410, opening the lid and removing the animal once the bath is complete.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “small animal washing device”, “washing device”, and “device” are interchangeable and refer to the small animal washing device 100 of the present invention.

Notwithstanding the foregoing, the small animal washing device 100 of the present invention can be of any suitable size and configuration as is known in the art without affecting the overall concept of the invention, provided that it accomplishes the above-stated objectives. One of ordinary skill in the art will appreciate that the small animal washing device 100 as shown in FIGS. 1-4 are for illustrative purposes only, and that many other sizes and shapes of the small animal washing device 100 are well within the scope of the present disclosure. Although the dimensions of the small animal washing device 100 are important design parameters for user convenience, the small animal washing device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A small animal washing device for restraining and bathing a small animal, the small animal washing device comprising:
a housing;
a drain opening located at a bottom of the housing; and
a water inlet for a hose and a corresponding water inlet tube positioned on the housing;
wherein water is supplied through the water inlet and subsequently discharged onto the small animal via a plurality of water delivery apertures positioned within the housing;
wherein the housing comprises at least two openings for placing a user's hands when washing the small animal;
wherein the housing retains all water contained within while the small animal is being washed; and
further wherein the housing is suitably sized so as to be portable and capable of temporarily housing the small animal during washing.

2. The small animal washing device of claim 1, wherein the housing is shaped as a rectangular box structure comprising a bottom wall, a top wall, a first lateral wall, a second lateral wall, a back wall and a front wall.

3. The small animal washing device of claim 2, wherein the housing comprises a hinged lid secured to the back wall via hinges.

4. The small animal washing device of claim 3, wherein the housing is manufactured of transparent or translucent plastic, such that a user can view an interior of the housing.

5. The small animal washing device of claim 4, wherein the at least two openings comprise sliding doors which seal and unseal the at least two openings.

6. The small animal washing device of claim 5, wherein the housing comprises a tray component with a bottom member and a raised perimeter, where the small animal sits on the tray component during bathing.

7. The small animal washing device of claim 6, wherein the tray component is angled such that water runs down to one end.

8. The small animal washing device of claim 7, wherein the bottom member of the tray component comprises a plurality of perforations for drainage.

9. The small animal washing device of claim 8, wherein the drain opening is a water release valve.

10. The small animal washing device of claim 9, wherein the tray component comprises a drain opening fluidly coupled to the drain opening in the housing.

11. The small animal washing device of claim 10, wherein the water inlet comprises an actuator valve for selectively opening or closing the water inlet tube.

12. The small animal washing device of claim 11, wherein the plurality of water delivery apertures comprise a plurality of nozzles positioned within the housing.

13. A small animal washing device for restraining and bathing a small animal, the small animal washing device comprising:
a housing with a hinged lid;
a drain opening located at a bottom of the housing;
a water inlet for a hose and a corresponding water inlet tube positioned on the housing; and
a tray component with a bottom member and a raised perimeter positioned within the housing;
wherein the small animal sits on the tray component during bathing;
wherein the tray component is angled such that water runs down to one end;
wherein water is supplied through the water inlet and subsequently discharged onto the small animal via a plurality of nozzles positioned within the housing;
wherein the housing comprises at least two openings for placing a user's hands when washing the small animal and sliding doors which seal and unseal the at least two openings;
wherein the hinged lid is pivoted downward in a horizontal orientation during use; and
further wherein the housing retains all water contained within while the small animal is being bathed.

14. The small animal washing device of claim 13, wherein the housing is manufactured of a transparent or translucent plastic, such that a user can view an interior of the housing. The small animal washing device of claim 13, wherein the housing comprises a liquid venturi unit.

16. The small animal washing device of claim 13, wherein the housing comprises a plurality of indicia.

17. The small animal washing device of claim 13, wherein the drain opening is a water release valve.

18. The small animal washing device of claim 17, wherein the tray component comprises a drain opening fluidly coupled to the drain opening in the housing.

19. The small animal washing device of claim 18, wherein the water inlet comprises an actuator valve for selectively opening or closing the water inlet tube.

20. A method of bathing an animal while keeping the animal calm and comfortable, the method comprising the steps of:
providing an animal washing device comprising a housing with a hose inlet and a tray component with a drain opening, and two hand openings for washing the animal;
positioning the animal within the housing, such that the animal sits or stands on the tray component;
shutting the lid of the device to retain the animal within the housing during use;
placing a user's hands through the hand openings to be able to wash the animal within the housing;
washing the animal within the device and draining the water once done; and
opening the lid and removing the animal once the bath is complete.
